(19) United States
(12) Patent Application Publication
(10) Pub. No.: US 2026/0257543 A1
(43) Pub. Date: Sep. 3, 2026

(54) TAILGATE AND VEHICLE BODY STRUCTURE INCLUDING SAME

(71) Applicants: Hyundai Motor Company, Seoul (KR); Kia Corporation, Seoul (KR)

(72) Inventors: Kyu Nam Jeon, Hwaseong-si (KR); Sang Hyun Lee, Hwaseong-si (KR); Sung Won Hong, Incheon (KR); Min Su Kim, Seoul (KR)

(21) Appl. No.: 19/176,770

(22) Filed: Apr. 11, 2025

(30) Foreign Application Priority Data
Dec. 26, 2024 (KR) 10-2024-0197640

(51) Int. Cl. B60J 5/10

(52) U.S. Cl. CPC B60J 5/103; B60J 5/106

(57) ABSTRACT

A tailgate coupled to a vehicle body having a loading space includes an upper gate portion coupled to the vehicle body to open and close an upper portion of the loading space and a lower gate portion coupled to the vehicle body to open and close a lower portion of the loading space, wherein a portion of the upper gate portion is rotatable toward the inside of the loading space.

### CROSS-REFERENCE TO RELATED APPLICATIONS

This application claims benefit of priority to Korean Patent Application No. 10-2024-0197640 filed on Dec. 26, 2024 in the Korean Intellectual Property Office, the disclosure of which is incorporated herein by reference in its entirety.

### TECHNICAL FIELD

The present disclosure relates to a tailgate and a body structure including the same.

### BACKGROUND

Tailgates of vehicles are generally located at the rear of vehicles and serve to seal or open trunk space from the outside. Tailgates are installed in various vehicles, such as passenger cars, SUVs, and trucks, and the basic configuration and operating principle of tailgates may vary depending on the type of vehicle in which they are installed. In general, tailgates are hingedly coupled to vehicle bodies and are opened and closed manually or electrically.

Meanwhile, a split tailgate is formed by dividing a tailgate into two independent panels and opened and closed up and down or left and right, thereby increasing the efficiency of space utilization and being used flexibly in various situations. The split tailgate has the advantage of being easy to use even in a small space when loading or unloading items and may improve user convenience by allowing upper and lower or left and right panels to be operated individually.

### SUMMARY

An aspect of the present disclosure is to provide a tailgate and a vehicle body structure including the same, capable of improving the convenience of vehicle use by opening a loading space.

According to an aspect of the present disclosure, a tailgate coupled to a vehicle body having a loading space includes: an upper gate portion coupled to the vehicle body to open and close an upper portion of the loading space; and a lower gate portion coupled to the vehicle body to open and close a lower portion of the loading space, wherein a portion of the upper gate portion is rotatable toward the inside of the loading space.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a schematic perspective view of a vehicle structure according to an embodiment of the present disclosure;

FIG. 2 is a perspective view illustrating an upper gate portion and a lower gate portion in a vehicle structure, where the upper gate portion and lower gate portion are positioned to fully open a loading space of the vehicle according to an embodiment of the present disclosure;

FIG. 3 is a schematic exploded perspective view of a vehicle structure according to an embodiment of the present disclosure;

FIG. 4 is a perspective view illustrating that an upper gate portion in a vehicle structure opens an upper portion of a loading space according to an embodiment of the present disclosure;

FIG. 5 is a perspective view illustrating that a lower gate portion in a vehicle structure opens a lower portion of a loading space according to an embodiment of the present disclosure;

FIG. 6 is a diagram illustrating a connection relationship among a driving unit, an upper support gate, an upper swing gate, and a lower swing gate in a tailgate according to an embodiment of the present disclosure;

FIG. 7 is a schematic perspective view of a first driving unit according to an embodiment of the present disclosure;

FIG. 8 is a diagram illustrating an operation of an upper swing gate rotating downwardly in a tailgate according to an embodiment of the present disclosure;

FIG. 9 is a schematic perspective view of a second driving unit according to an embodiment of the present disclosure;

FIG. 10 is a diagram illustrating an operation of an upper swing gate rotating upwardly in a tailgate according to an embodiment of the present disclosure;

FIG. 11 is a perspective view illustrating a second mode of a vehicle structure according to an embodiment of the present disclosure; and

FIG. 12 is a perspective view illustrating a state in which a lower gate portion opens a lower portion of a loading space in a second mode of a vehicle structure according to an embodiment of the present disclosure.

### DETAILED DESCRIPTION OF ILLUSTRATIVE EMBODIMENTS

While the present disclosure may be modified in various manners and take on various alternative forms, specific embodiments thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure. As used herein, the term “and/or” includes any and all combinations of one or more of the associated listed items.

The terms, such as “unit, part, portion, etc.” may be used to describe various components, but the components should not be limited by these terms. The above terms may refer to not only physically/visually distinct components, but also to functions or components of a portion even if the corresponding portion is not clearly divided.

The terms used herein to describe embodiments of the present disclosure is not intended to limit the scope of the present disclosure. The articles “a,” and “an” are singular in that they have a single referent, however the use of the singular form in the present document should not preclude the presence of more than one referent. In other words, elements of the present disclosure referred to in the singular may number one or more, unless the context clearly indicates otherwise. It will be further understood that the terms “comprise,” “comprising,” “include,” and/or “including,” when used herein, specify the presence of stated features, numbers, steps, operations, elements, and/or components but do not preclude the presence or addition of one or more other features, numbers, steps, operations, elements, components, and/or groups thereof.

Unless defined in a different way, all the terms used herein including technical and scientific terms have the same meanings as understood by those skilled in the art to which the present disclosure pertains. Such terms as defined in generally used dictionaries should be construed to have the same meanings as those of the contexts of the related art, and unless clearly defined in the application, they should not be construed to have ideally or excessively formal meanings.

In the description below, the terms “anterior,” “posterior,” “lateral,” “front,” “rear,” “up/down,” “above,” “upper,” “top,” “below” “lower” “bottom” “left/right” and the like are defined based on a vehicle or vehicle body.

Hereinafter, embodiments of the present disclosure will be described with reference to the accompanying drawings.

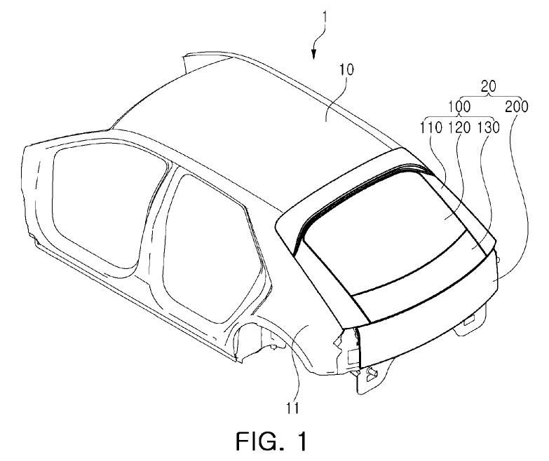

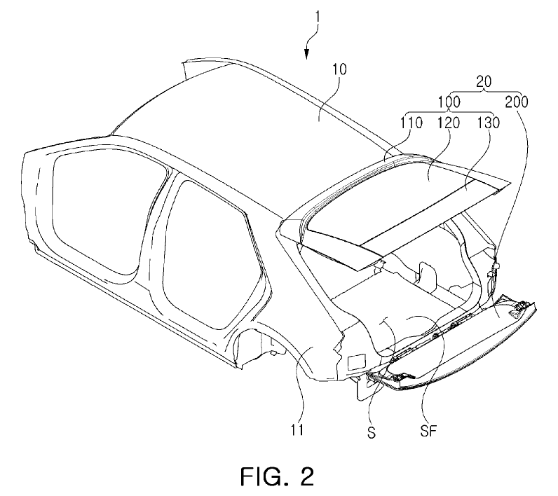

FIG. 1 is a schematic perspective view of a vehicle structure according to an embodiment of the present disclosure, and FIG. 2 is a perspective view illustrating a state in which an upper gate portion and a lower gate portion of a vehicle structure according to an embodiment of the present disclosure fully open a loading space.

Referring to FIGS. 1 and 2, a vehicle structure 1 according to an embodiment of the present disclosure may include a vehicle body 10 and a tailgate 20.

The vehicle body 10 may refer to a component forming a basic structure of a vehicle. The vehicle body 10 may include a chassis or frame, which is a basic skeleton of the vehicle. The vehicle body 10 may support various equipment and parts forming the vehicle. The vehicle body 10 may include a loading space S. The loading space S may be provided at the rear of the vehicle body 10. The loading space S may be opened and closed by the tailgate 20. The tailgate 20 may be rotatably provided on the vehicle body 10. The tailgate 20 may rotate to expose the loading space S of the vehicle body 10 externally or seal the loading space S from the outside. For example, the tailgate 20 may be mounted on the tailgate frame 11 of the vehicle body 10 forming the loading space S or may be separated from the tailgate frame 11 to open and close the loading space S.

The tailgate 20 may be coupled to the vehicle body 10. For example, the tailgate 20 may be rotatably coupled to the rear of the vehicle body 10 to open and close the rear loading space S of the vehicle body 10. The tailgate 20 may be provided as a split tailgate. For example, the tailgate 20 may separately open and close the upper and lower portions of the loading space 10. The tailgate 20 may include an upper gate portion 100 and a lower gate portion 200. The upper gate portion 100 may be rotatably coupled to the vehicle body 10 and may open and close the upper portion of the loading space S. The lower gate portion 200 may be rotatably coupled to the vehicle body 10 and may open and close the lower portion of the loading space S. The upper gate portion 100 and the lower gate portion 200 may operate independently.

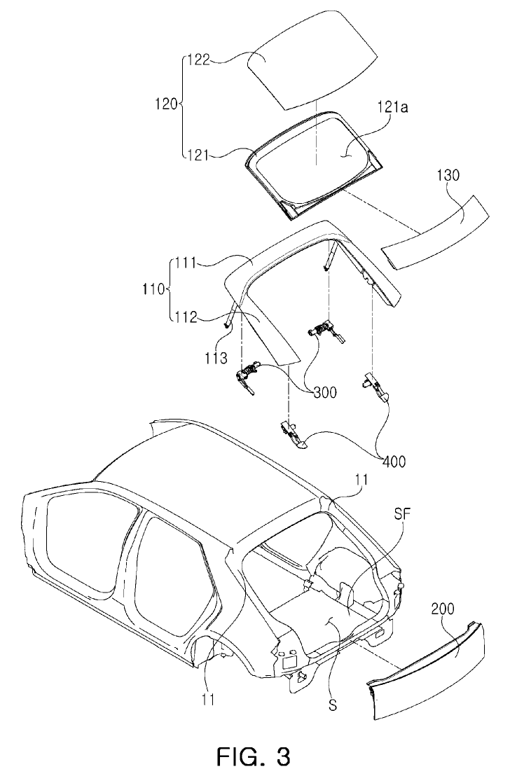

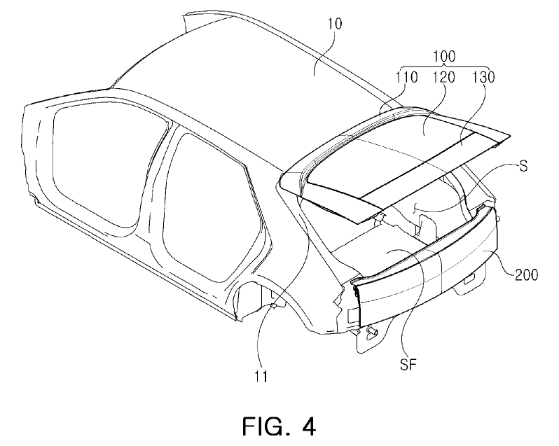

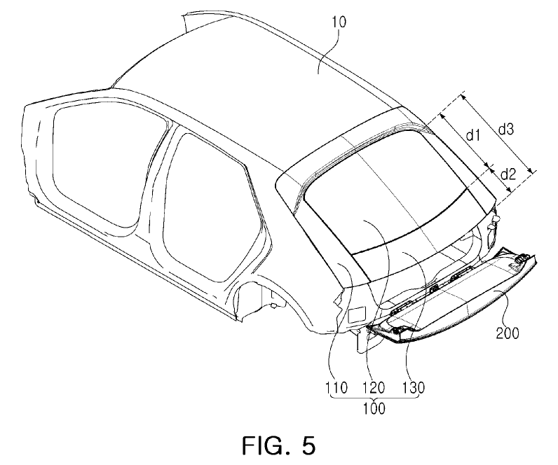

FIG. 3 is a schematic exploded perspective view of a vehicle structure according to an embodiment of the present disclosure, FIG. 4 is a perspective view illustrating that an upper gate portion in a vehicle structure opens an upper portion of a loading space according to an embodiment of the present disclosure, and FIG. 5 is a perspective view illustrating that a lower gate portion in a vehicle structure opens a lower portion of a loading space according to an embodiment of the present disclosure.

Referring to FIGS. 3 to 5, the upper gate portion 100 and the lower gate portion 200 may operate independently to open and close the loading space S of the vehicle body 10. The upper gate portion 100 may be provided in an upper portion at the rear of the vehicle body 10. The upper gate portion 100 may open and close the upper portion of the loading space S. For example, the upper gate portion 100 may rotate upwardly to open the upper portion of the loading space S or may rotate downwardly, while the upper portion of the loading space S is open, to close the upper portion of the loading space S. The lower gate portion 200 may be provided in a lower portion at the rear of the vehicle body 10. The lower gate portion 200 may open and close the lower portion of the loading space S. For example, the lower gate portion 200 may rotate downwardly to open the lower portion of the loading space S or may rotate upwardly, while the lower portion of the loading space S is open, to close the lower portion of the loading space S.

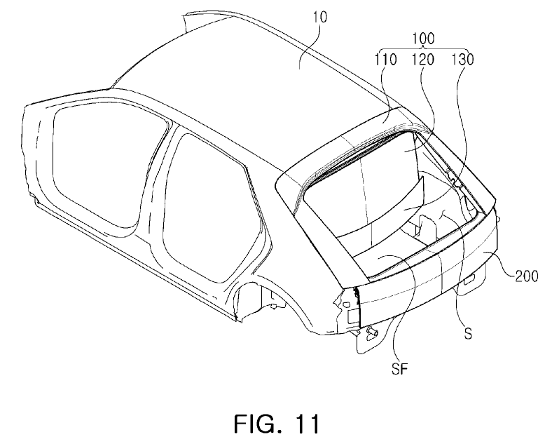

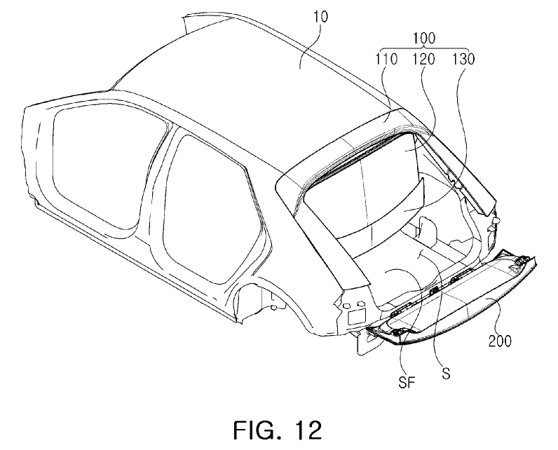

The upper gate portion 100 may be rotatably hinge-coupled to the vehicle body 10. A portion of the upper gate portion 100 may be provided to be rotatable toward the inside of the loading space S (see FIG. 11). For example, when the upper gate portion 100 is secured to the rear upper end portion of the vehicle body 10 (the upper portion of the loading space is sealed), a portion of the upper gate portion 100 may rotate downwardly toward the inside of the loading space S. The rear upper end portion of the vehicle body 10 may correspond to the tailgate frame 11. When at least a portion of the upper gate portion 100 rotates toward the inside of the loading space S, a floor surface SF of the loading space S may be exposed externally. The portion of the upper gate portion 100 rotated toward the inside of the loading space S may form a side wall of the loading space S. For example, the portion of the upper gate portion 100 rotated toward the inside of the loading space S may form the loading space S together with the vehicle body 10 and may form the front side wall of the loading space S (see FIGS. 11 and 12).

The upper gate portion 100 may include, for example, an upper support gate 110, an upper swing gate 120, and a lower swing gate 130. The upper gate portion 100 may be switched between a first mode and a second mode.

The first mode may refer to a state in which the upper support gate 110, the upper swing gate 120, and the lower swing gate 130 of the upper gate portion 100 may rotate integrally. In the first mode, the opposite edges of the upper support gate 110, the upper swing gate 120, and the lower swing gate 130 may be in close contact with each other. In the first mode, the upper gate portion 100 may be integrally rotated upwardly or downwardly to open and close the upper portion of the loading space S.

The second mode may refer to a state in which the edges of the upper support gate 110, the upper swing gate 120, and the lower swing gate 130 are all detachable. In the second mode, the upper swing gate 120 and the lower swing gate 130 may be rotated inwardly from the upper support gate 110 to the loading space S. In the second mode, the upper swing gate 120 may form a portion of the front side wall of the loading space S. In the second mode, the lower swing gate 130 may be disposed at the rear of the upper swing gate 120 (see FIGS. 11 and 12). When the lower swing gate 130 is disposed at the rear of the upper swing gate 120, the lower swing gate 130 may be disposed to overlap the upper swing gate 120 at least partially in a longitudinal direction. The lower swing gate 130 may prevent the upper swing gate 120 from being damaged by a load, cargo, etc. loaded in the loading space S.

The upper support gate 110 may be rotatably coupled to the vehicle body 10. For example, the upper support gate 110 may be hinge-coupled to the upper side of the tailgate frame 11 of the vehicle body 10. The upper support gate 110 may include a transverse panel 111 rotatably hinge-coupled to the vehicle body 10 and a longitudinal panel 112 protruding from both sides of the transverse panel 111 in in a width direction. The transverse panel 111 and the longitudinal panel 112 may be provided in a channel shape (i.e., '⊏' shape) as a whole. The transverse panel 111 and the longitudinal panel 112 may be provided integrally. It is also possible to manufacture the transverse panel 111 and the longitudinal panel 112 as separate members and then couple them. Bottom surfaces of the transverse panel 111 and the longitudinal panel 112 may be attached to or separated from the vehicle body 10 as the upper support gate 110 rotates. A spindle 113 may be connected to the upper support gate 110. The spindle 113 may be connected to the vehicle body 10 on one side and to the upper support gate 110 on the other side to stably rotate the upper support gate 110.

The upper swing gate 120 may be rotatably connected to the upper support gate 110. For example, the upper swing gate 120 may have one side rotatably connected to the transverse panel 111 of the upper support gate 110. The upper swing gate 120 may be rotated by the first driving unit 300. The first driving unit 300 may connect the upper support gate 110 to the upper swing gate 120. The first driving unit 300 may be controlled by a separate controller. The controller may be provided as an arithmetic device including at least one microprocessor controlling the overall operation of the tailgate 20. The first driving unit 300 may rotate the upper swing gate 120. For example, when the upper support gate 110 is secured to the vehicle body 10, the first driving unit 300 may rotate the upper swing gate 120 toward the inside of the loading space S. As the upper swing gate 120 is rotated toward the inside of the loading space S, the lower swing gate 130 connected to the upper swing gate 120 may also be rotated to the inside of the loading space S.

When the upper swing gate 120 rotates to the inside of the loading space S, the upper swing gate 120 may form a side wall of the loading space S. The upper swing gate 120 may form the loading space S together with the vehicle body 10.

The upper swing gate 120 may include, for example, an upper swing gate panel 121 and a rear glass 122. The upper swing gate panel 121 may have an outer edge conforming to an inner edge of the upper support gate 110. In the first mode in which the upper swing gate 120 is coupled to the upper support gate 110, the outer edge of the upper swing gate panel 121 may be closely attached to the inner edge of the upper support gate 110. An opening 121a may be provided on the inner side of the upper swing gate panel 121. The rear glass 122 may be coupled to the upper swing gate panel 121. The rear glass 122 may seal the opening 121a of the upper swing gate panel 121.

A widthwise outer edge length d1 of the upper swing gate 120 may be shorter than a widthwise inner edge length d3 of the upper support gate 110. The lower swing gate 130 may be connected to the lower side of the upper swing gate 120. A widthwise outer edge length d2 of the lower swing gate 130 may be equal to or smaller than a difference between the widthwise inner edge length d3 of the upper support gate 110 and the widthwise outer edge length d1 of the upper swing gate 120. In the first mode of the upper gate portion 100, the inner upper edge of the upper support gate 110 may be in close contact with the upper swing gate 120, and both inner edges of the upper support gate 110 may be in close contact with the upper swing gate 120 and the lower swing gate 130.

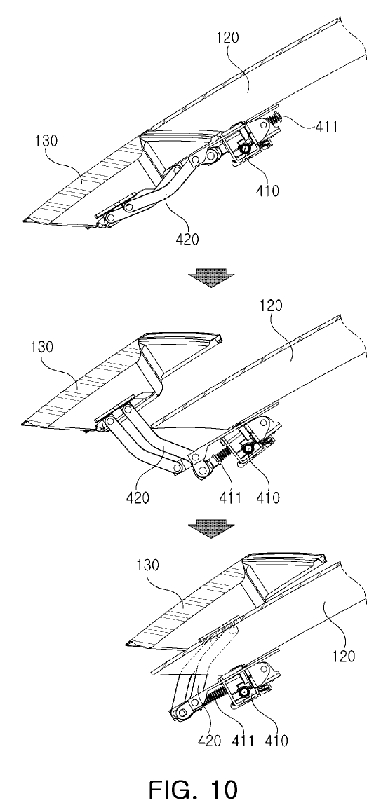

The lower swing gate 130 may be rotatably connected to the upper swing gate 120. For example, the upper swing gate 120 may be rotatably connected to the upper support gate 110 on one side, and the lower swing gate 130 may be rotatably connected to the other side of the upper swing gate 120. The lower swing gate 130 may be provided below the upper swing gate 120. The lower swing gate 130 may be connected to the upper swing gate 120 and may move in conjunction with the upper swing gate 120. When the upper swing gate 120 rotates toward the inside of the loading space S, the lower swing gate 130 may also move toward the inside of the loading space S. The lower swing gate 130 may be rotated upwardly from the upper swing gate 120. When the lower swing gate 130 rotates upwardly from the upper swing gate 120, the lower swing gate 130 may be disposed so that at least a portion thereof overlaps the upper swing gate 120 in the longitudinal direction of the vehicle body (see FIG. 10). The lower swing gate 130 may, for example, rotate upwardly and be disposed at the rear of the upper swing gate 120 (see FIG. 11). The lower swing gate 130 may be rotated by the second driving unit 400. The second driving unit 400 may connect the upper swing gate 120 to the lower swing gate 130 and rotate the lower swing gate 130. The second driving unit 400 may be controlled by the controller.

The lower gate portion 200 may be coupled to the vehicle body 10. For example, the lower gate portion 200 may be provided below the tailgate frame 11 provided at the rear of the vehicle body 10. The tailgate frame 11 may refer to an upper portion of a frame forming the loading space S at the rear of the vehicle body 10. The lower gate portion 200 may operate separately from the upper gate portion 100. The lower gate portion 200 may be driven independently. The lower gate portion 200 may open and close the lower portion of the loading space S. In a sealed state of the loading space S, at least a portion of the end portion of the lower gate portion 200 may be in close contact with one end portion of the lower swing gate 130. The one end portion of the lower swing gate 130 may refer to an end portion in which the lower swing gate 130 is not connected to the upper swing gate 120. The lower gate portion 200 may be operated manually or may be connected to a separate driving unit (not shown) and operated by a controller.

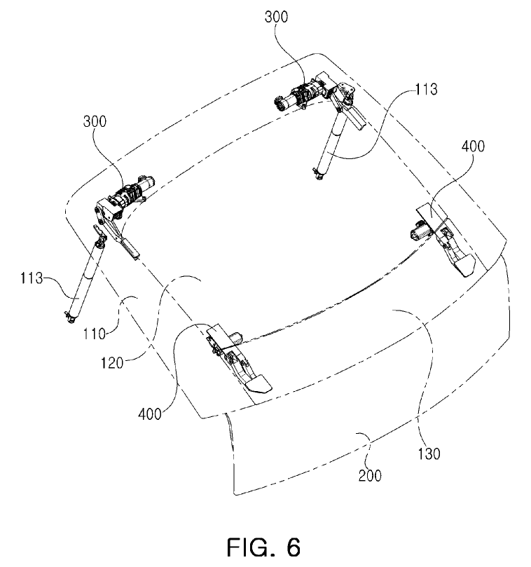

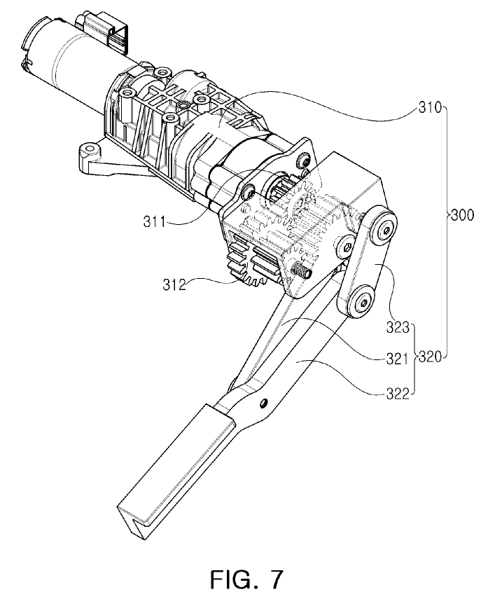

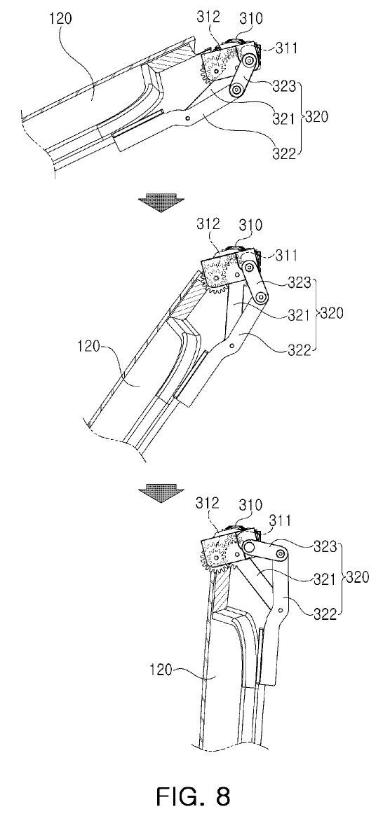

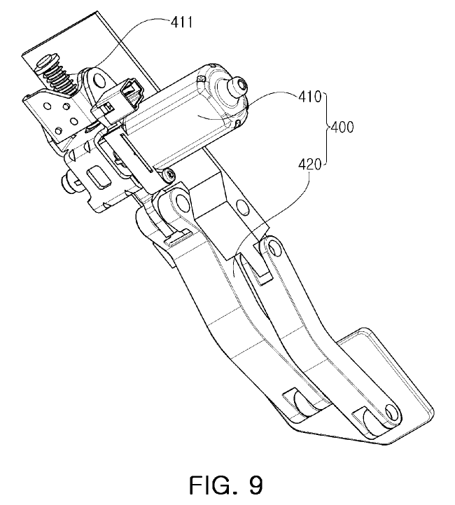

FIG. 6 is a diagram illustrating a connection relationship among a driving unit, an upper support gate, an upper swing gate, and a lower swing gate in a tailgate according to an embodiment of the present disclosure, FIG. 7 is a schematic perspective view of a first driving unit according to an embodiment of the present disclosure, FIG. 8 is a diagram illustrating an operation of an upper swing gate rotating downwardly in a tailgate according to an embodiment of the present disclosure, FIG. 9 is a schematic perspective view of a second driving unit according to an embodiment of the present disclosure, and FIG. 10 is a diagram illustrating an operation of an upper swing gate rotating upwardly in a tailgate according to an embodiment of the present disclosure.

Referring to FIGS. 6 to 10, the first driving unit 300 may be provided to rotate the upper swing gate 120. For example, the first driving unit 300 may be provided to rotate the upper swing gate 120 toward the inside of the loading space S in the second mode of the upper gate portion 100. In other words, the first driving unit 300 may rotate the upper swing gate 120 downwardly toward the inside of the loading space when the upper support gate 110 comes into contact with the vehicle body 10.

Referring to FIG. 7, the first driving unit 300 may include, for example, a first driving motor 310 and a first link module 320. The first driving motor 310 may be connected to the upper support gate 110. The first link module 320 may be connected to the upper swing gate 120.

The first driving motor 310 may be controlled by the controller. The first driving motor 310 may rotate the first link module 320 according to a signal from the controller.

The first link module 320 may rotate the upper swing gate 120 upon receiving power from the first driving motor 310. The first driving motor 310 and the first link module 320 may be mechanically connected by connecting gears 311 and 312. That is, rotational power of the first driving motor 310 may be transmitted to the first link module 320 through the connecting gears 311 and 312.

The first link module 320 may be provided as various link modules commonly used in the art to which the present disclosure pertains, as long as it corresponds to a component capable of rotating the upper swing gate 120 upwardly or downwardly by the first driving motor 310. For example, the first link module 320 may be provided as a four-joint link module. For convenience of description, a case in which the first link module 320 is provided as a four-joint link module is described as an example.

A rotational motion of the upper swing gate 120 will be described with reference to FIG. 8. The first link module 320 may include a first link 321, a second link 322, and a hinge link 323. When the first driving motor 310 rotates counterclockwise, the first connecting gear 311 may rotate counterclockwise. As the first connecting gear 311 rotates counterclockwise, the second connecting gear 312 may rotate clockwise. When the second connecting gear 312 rotates clockwise, the first link 321 may rotate counterclockwise. When the first link 321 rotates counterclockwise, the second link 322 connected to the first link 321 may rotate counterclockwise. At this time, the first link 321 may be connected to the inner side of the second link 322. One end portion of the second link 322 may be connected to the upper swing gate 120 and the other end thereof may be connected to the first hinge link 323. When the second link 322 rotates counterclockwise, the upper swing gate 120 may rotate downwardly toward the inside of the loading space S. The first drive motor 310 may rotate the first link 321 until the end portion of the upper swing gate 120 comes into contact with the floor surface SF of the loading space S. The operation of the upper swing gate 120 which rotates upwardly may be performed in the reverse order of the process described above.

Referring to FIG. 9, the second driving unit 400 may be provided to rotate the lower swing gate 130. The second driving unit 400 may connect the upper swing gate 120 to the lower swing gate 130. When the upper swing gate 120 rotates downwardly toward the inside of the loading space S, the second driving unit 400 may rotate the lower swing gate 130 upwardly toward the outside of the upper swing gate 120. When the lower swing gate 130 is rotated upwardly by the second driving unit 400, at least a portion of the lower swing gate 130 may be disposed to face the upper swing gate 120 in the longitudinal direction.

The second driving unit 400 may include, for example, a second driving motor 410 connected to the upper swing gate 120 and a second link module 420 rotating the lower swing gate 130 upon receiving power from the second driving motor 410.

The second driving motor 410 may be controlled by the controller. The second driving motor 410 may rotate the second link module 420 according to a signal from the controller. The second driving motor 410 may include a worm shaft 411. The worm shaft 411 may move linearly when the second driving motor 410 is driven.

The second link module 420 may rotate the lower swing gate 130 upon receiving power from the second driving motor 410. The second link module 420 may be provided as various link modules commonly used in the art to which the present disclosure pertains, as long as it corresponds to a component capable of rotating the lower swing gate 130 upwardly or downwardly by the second driving motor 410. The second link module 420 may have one side hinge-coupled to the second driving motor 420 and the other side hinge-coupled to the lower swing gate 130.

A rotational motion of the lower swing gate 130 is described with reference to FIG. 10. When the second driving motor 410 drives, the worm shaft 411 may move linearly in the left direction. When the worm shaft 411 moves linearly in the left direction, the second link module 420 may rotate upwardly at a left end portion. When the left end portion of the second link module 420 rotates upwardly, the lower swing gate 130 rotates upwardly accordingly and may be disposed to overlap the upper swing gate 120 in the longitudinal direction. By arranging the lower swing gate 130 to overlap the upper swing gate 120, the upper swing gate 120 may be prevented from being damaged by a load loaded in the loading space S. The downward rotation of the lower swing gate 130 may be performed in the reverse order of the process described above.

The tailgate and the vehicle body structure including the tailgate according to embodiments of the present disclosure may selectively open the loading space, thereby improving the convenience of vehicle use.

While embodiments have been shown and described above, it will be apparent to those skilled in the art that modifications and variations could be made without departing from the scope of the present disclosure as defined by the appended claims.

What is claimed is:

1. A tailgate coupled to a vehicle body having a loading space, the tailgate comprising:
an upper gate portion coupled to the vehicle body to open and close an upper portion of the loading space; and
a lower gate portion coupled to the vehicle body to open and close a lower portion of the loading space,
wherein a portion of the upper gate portion is rotatable toward an inside of the loading space.

2. The tailgate of claim 1, wherein, in a state in which the upper gate portion is secured to a rear upper end of the vehicle body, a portion of the upper gate portion rotates downwardly toward the inside of the loading space to expose a floor surface of the loading space externally.

3. The tailgate of claim 2, wherein the portion of the upper gate portion rotated toward the inside of the loading space constitutes a side wall of the loading space.

4. The tailgate of claim 1, wherein the upper gate portion includes:
an upper support gate rotatably coupled to the vehicle body;
an upper swing gate having one side rotatably coupled to the upper support gate; and
a lower swing gate rotatably coupled to another side of the upper swing gate.

5. The tailgate of claim 4, wherein the upper swing gate and the lower swing gate are rotatable from the upper support gate to the inside of the loading space.

6. The tailgate of claim 5, wherein, when the upper swing gate and the lower swing gate rotate to the inside of the loading space, the upper swing gate forms a side wall of the loading space and the lower swing gate rotates upwardly to at least partially overlap the upper swing gate in a longitudinal direction.

7. The tailgate of claim 4, wherein the upper support gate includes:
a transverse panel rotatably hinge-coupled to the vehicle body; and
a longitudinal panel protruding from both sides of the transverse panel in a width direction,
wherein bottom surfaces of the transverse panel and the longitudinal panel are mounted on or separated from the vehicle body as the upper support gate rotates.

8. The tailgate of claim 4, further comprising a first driving unit connecting the upper support gate to the upper swing gate and rotating the upper swing gate.

9. The tailgate of claim 8, wherein the first driving unit rotates the upper swing gate downwardly toward the inside of the loading space when the upper support gate comes into contact with the vehicle body.

10. The tailgate of claim 8, wherein the first driving unit includes:
a first driving motor connected to the upper support gate; and
a first link module rotating the upper swing gate upon receiving power from the first driving motor.

11. The tailgate of claim 4, wherein the upper swing gate includes:
an upper swing gate panel having an outer edge conforming to an inner edge of the upper support gate and having an opening formed on an inner edge thereof; and
a rear glass coupled to the upper swing gate panel to block the opening.

12. The tailgate of claim 4, further comprising a second driving unit connecting the upper swing gate to the lower swing gate and rotating the lower swing gate.

13. The tailgate of claim 12, wherein, when the upper swing gate rotates downwardly toward the inside of the loading space, the second driving unit rotates the lower swing gate upwardly to an outside of the upper swing gate to dispose the lower swing gate to face the upper swing gate in a longitudinal direction.

14. The tailgate of claim 12, wherein the second driving unit includes:
a second driving motor connected to the upper swing gate; and
a second link module rotating the lower swing gate upon receiving power from the second driving motor.

15. The tailgate of claim 4, wherein:
the upper gate portion is switchable between a first mode in which opposing edges of the upper support gate, the upper swing gate, and the lower swing gate are in contact with each other, and
a second mode in which the edges of the upper support gate, the upper swing gate, and the lower swing gate are all separated.

16. The tailgate of claim 15, wherein the upper gate portion rotates integrally to open and close the loading space in the first mode.

17. The tailgate of claim 15, wherein, in the second mode, the upper swing gate forms a portion of a front side wall of the loading space and the lower swing gate is disposed at a rear of the upper swing gate.

18. A vehicle structure comprising:
a vehicle body having a loading space; and
a tailgate, the tailgate comprising:
an upper gate portion coupled to the vehicle body to open and close an upper portion of the loading space; and
a lower gate portion coupled to the vehicle body to open and close a lower portion of the loading space,
wherein a portion of the upper gate portion is rotatable toward an inside of the loading space.

19. The vehicle structure of claim 18, wherein, in a state in which the upper gate portion is secured to a rear upper end of the vehicle body, a portion of the upper gate portion rotates downwardly toward the inside of the loading space to expose a floor surface of the loading space externally.

20. A tailgate coupled to a vehicle body having a loading space, the tailgate comprising:
an upper gate portion coupled to the vehicle body to open and close an upper portion of the loading space,
wherein a portion of the upper gate portion is rotatable toward an inside of the loading space.
